(19) United States
(12) Patent Application Publication
(10) Pub. No.: US 2005/0213271 A1
(43) Pub. Date: Sep. 29, 2005

(54) Electrostatic discharge protection circuits

(76) Inventors: Nui Chong, San Jose, CA (US); Aaron Rogers, Pflugerville, TX (US); Kerry Ilgenstein, Austin, TX (US)

Correspondence Address: Greg J. Michelson;MacPHERSON KWOK CHEN & HEID LLP, Suite 226, 1762 Technology Drive, San Jose, CA, 95110, US

(21) Appl. No.: 10/808,627

(22) Filed: Mar. 24, 2004

(51) Int. Cl. H02H 9/00

(52) U.S. Cl. 361/56

(57) ABSTRACT

Systems and methods disclosed provide electrostatic discharge protection. For example, in accordance with an embodiment of the present invention, a circuit is disclosed having a diode string and a transistor in a cascode configuration that provides electrostatic discharge (ESD) protection and can operate in a mixed voltage environment.

### TECHNICAL FIELD

The present invention relates generally to electrical circuits and, more particularly, to circuits having or requiring electrostatic discharge protection.

### BACKGROUND

A modern integrated circuit design often is required to provide input/output (I/O) ports or interfaces that can operate at a number of different power supply voltages to support a variety of applications. Additionally, besides having to transmit and/or receive information via one or more input/output ports that can accommodate different power supply voltages (e.g., mixed voltage I/O), the I/O ports generally must also be designed to have electrostatic discharge protection.

There are often constraints that limit the available design options. For example, there are often a limited number of transistor types that are available in a given technology (e.g., 1.2 V and 2.5 V transistors in a 2.5 V semiconductor processing technology) that have low processing costs. To support higher voltages (e.g., 3.3 V or 5 V), transistors are often stacked in a cascode configuration to satisfy certain design requirements, such as for example dielectric and hot carrier reliability limits and leakage current constraints.

This configuration of transistors stacked in a cascode configuration is widely employed as an electrostatic discharge (ESD) protection device for I/O circuits and power rails. For example, FIGS. 1a and 1b show an exemplary circuit implementation of cascoded N-channel metal oxide semiconductor (NMOS) transistors for electrostatic discharge protection for power rails and I/O circuits, respectively, such as for example for mixed voltage applications (e.g., allow different power supply voltages or I/O signal voltage levels).

As shown in FIG. 1a, transistors 102 and 104 (top and bottom transistors, respectively) are stacked between a supply voltage (labeled VCC) and a reference voltage (e.g., ground), with a resistor 106 connecting a gate terminal of transistor 104 to the reference voltage. The circuit, for example, can serve as an ESD protection circuit for power rails. As shown in FIG. 1b, transistors 110 and 112 (top and bottom transistors, respectively) are stacked between a supply voltage (labeled VCC) and a reference voltage, with a pull-up circuit 108 connected between the supply voltage and a drain terminal of transistor 110, and an I/O pad connected to a drain terminal of transistor 110. A control signal (labeled VCTRL) is provided to a gate terminal of transistors 112 via an inverter 114. This circuit, for example, can be an ESD-robust output buffer driver as well as a dedicated ESD protection circuit for the I/O interface.

In general, the configurations illustrated in FIGS. 1a and 1b allow a maximum voltage (e.g., 3.3 V), which exceeds the operating voltage limit of a given processing technology (e.g., 2.5 V), applied at the supply voltage or the I/O pad to be reduced by the top transistor (e.g., between the drain and source by the threshold voltage (Vₜₕ) of 0.5 V) during normal operation. The gate terminal of transistor 102 or 110 can be biased at or near the supply voltage, with the voltage applied via the I/O pad for transistor 110. These configurations may allow both the top and bottom transistors (i.e., transistors 102 and 110 or transistors 104 and 112, respectively) to meet the dielectric and hot carrier reliability limits while avoiding excessive leakage current.

One drawback of the configurations illustrated in FIGS. 1a and 1b is their high snapback voltage that tends to reduce the overall level of ESD protection. As a result, there is a need for improved ESD protection circuits

### SUMMARY

Systems and methods are disclosed herein to provide electrostatic discharge protection. For example, in accordance with an embodiment of the present invention, a circuit is disclosed having a diode string and a transistor in a cascode configuration that provides electrostatic discharge (ESD) protection. The circuit, for example, may have a number of cascaded diodes and transistors. The circuit can operate in a mixed voltage environment and may provide a lower snapback voltage, a smaller layout, and/or improved ESD performance as compared to some conventional circuits.

More specifically, in accordance with one embodiment of the present invention, a circuit includes a diode string coupled to a supply voltage line; and a transistor coupled to the diode string and to a reference voltage line, wherein the diode string and the transistor are implemented in a cascode configuration and provide electrostatic discharge protection.

In accordance with another embodiment of the present invention, a programmable logic device includes at least a first diode coupled between a supply voltage line and a reference voltage line and adapted to protect from electrostatic discharge of a first polarity; at least a second diode coupled between the supply voltage line and the reference voltage line and adapted to protect from electrostatic discharge of a second polarity; and a transistor coupled between the at least first diode and the reference voltage line.

In accordance with another embodiment of the present invention, a method of providing electrostatic discharge protection includes providing at least a first diode coupled to a supply voltage rail to protect from electrostatic discharge of a first polarity; providing a transistor coupled between the at least first diode and a reference voltage rail; and providing at least a second diode coupled to the supply voltage rail and to the reference voltage rail or between the at least first diode and the transistor to protect from electrostatic discharge of a second polarity, wherein the at least first diode and the transistor are implemented in a cascode configuration.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIGS. 1a and 1b show conventional electrostatic discharge protection circuits.

FIGS. 2a and 2b show circuits having electrostatic discharge protection in accordance with an embodiment of the present invention.

FIG. 3 shows a circuit having electrostatic discharge protection in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

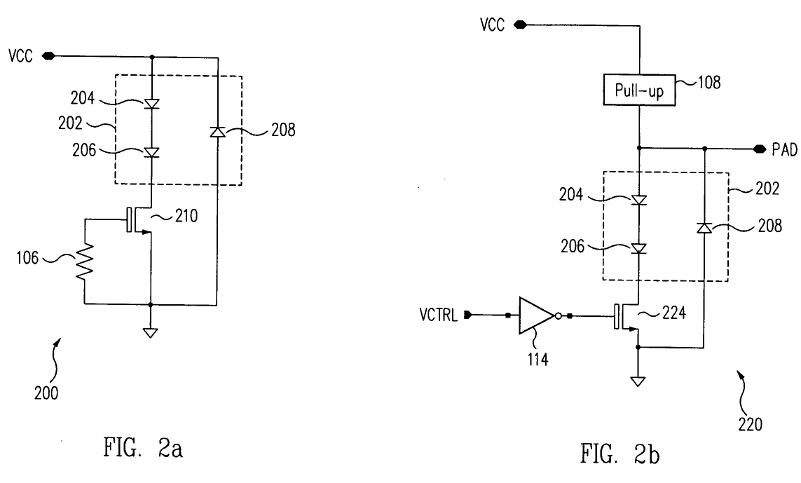

FIGS. 2a and 2b show circuits 200 and 220, respectively, which provide electrostatic discharge protection in accordance with an embodiment of the present invention. Circuits 200 and 220 are exemplary implementations for power rails and I/O circuit applications, respectively.

Circuit 200 includes diodes 204, 206, and 208, a transistor 210, and resistor 106. Circuit 220 includes diodes 204, 206, and 208, pull-up circuit 108, inverter 114 (optional), and a transistor 224. Diodes 204, 206, and/or 208 may be implemented with conventional diodes or, for example, with bipolar transistors or some combination of diodes and bipolar transistors.

The configuration of diodes 204 and 206 or diodes 204, 206, and 208 may be referred to as a diode string 202. The voltage drop across the p-n junctions of diodes 204 and 206 in diode string 202 allows transistor 210 (FIG. 2a) or transistor 224 (FIG. 2b) to meet reliability and leakage limits during normal operation. Diode 208 is configured in the reverse direction and functions to discharge ESD current having the opposite polarity of ESD current discharged by diodes 204 and 206 and transistor 224.

Transistor 210 or transistor 224 implemented in the cascode configuration with diode string 202 provides ESD protection (e.g., some level of ESD immunity) and is applicable, for example, in mixed voltage applications. As an example, circuit 200 or circuit 220 may be implemented within a programmable logic device (e.g., a field programmable gate array or a complex programmable logic device) to provide ESD protection for power rails (e.g., as a clamp) or at the I/O port, respectively. Circuit 220, besides providing ESD protection, may also function as a driver for output or input/output applications.

It should be understood that any number of diodes may be implemented to form diode string 202. For example, one, three, four or more diodes may be implemented in series in place of diodes 204 and 206 and, similarly, two, three, four or more diodes may be implemented in place of diode 208.

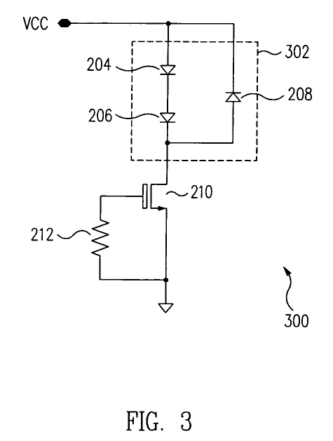

FIG. 3 shows a circuit 300 having electrostatic discharge protection in accordance with an embodiment of the present invention. Circuit 300 is similar to circuit 200 (FIG. 2a) and circuit 220 (FIG. 2b), but illustrates a diode string 302 having diode 208 in parallel only with diodes 204 and 206, rather than in parallel with diode 204, diode 206, and transistor 210 (FIG. 2a) or transistor 224 (FIG. 2b).

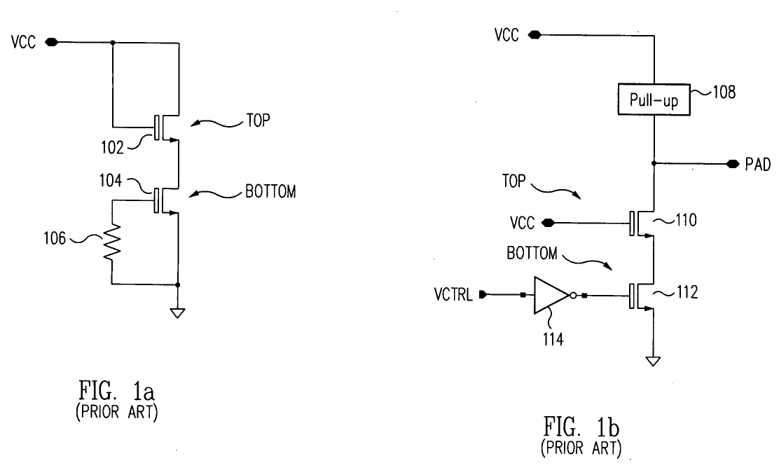

Diode string 202 replaces the top transistor (i.e., transistor 102 or transistor 110 of FIGS. 1a and 1b, respectively) in the cascode configuration. Referring briefly to FIGS. 1a and 1b, the cascoded NMOS transistors (i.e., transistors 102 and 104 or 110 and 112) physically share the same diffusion, which provides a parasitic lateral NPN channel for bipolar action during an ESD event. The top drain (i.e., the drain of transistor 102 or 110) acts as a collector, while the bottom source (i.e., the source of transistor 104 or 112) acts as an emitter. The top and bottom channel regions plus the center diffusion generally define the base width.

In general, there are one or more drawbacks with the cascode configuration of the NMOS transistors. For example, compared to a single NMOS transistor, the cascoded configuration has a much larger base width. Therefore, the snapback and holding voltages during an ESD event will increase considerably, which results in a higher clamping voltage that is not preferred for ESD protection. As another example, the cascode configuration requires the top and the bottom transistors to have the same number of fingers, even though the top NMOS transistor may be viewed as a dummy transistor.

Furthermore, the layout area of the top NMOS transistor increases and becomes a burden when the bottom NMOS transistor is a very large power clamp or an I/O buffer. If the top and bottom transistors are separated into different diffusion regions and the top transistor is made smaller to reduce the required layout area, the ESD performance suffers because the two separate parasitic bipolars are much harder to turn-on together. Unlike in the shared diffusion configuration, the ESD current will not be able to raise the body bias of the bottom NMOS transistor unless the bipolar action in the top NMOS transistor is in full swing. The resulting snapback and holding voltage will consequently be detrimentally much higher.

In contrast, certain aspects of one or more embodiments of the present invention may provide performance improvements over conventional techniques. For example, diodes (e.g., such as diode 204 and 206 or diode 208) discharge ESD current through their forward bias mode, which may be generally more efficient than the parasitic bipolar action of the cascoded transistors (e.g., transistors 102 and 104 or 110 and 112). Also, the turn-on voltage for the diodes is typically much lower. For example, a positive ESD event will easily turn-on diodes 204 and 206 within diode string 202 and then drive the bottom NMOS transistor (i.e., transistor 210 or 224) into bipolar action.

The overall snapback voltage and holding voltage will be close to the bipolar action of a single transistor plus the voltage potential drop of diode string 202. The overall failure, if a failure occurs, will more likely be caused by the bottom transistor (i.e., transistor 210 or 224). In terms of layout, a diode requires significantly less area to provide the same level of ESD protection as a transistor. Furthermore, the diode string and the bottom NMOS transistor are in different diffusion regions and, therefore, the diode string doesn't need to scale up with the bottom NMOS transistor. The resulting layout area will, consequently, be significantly smaller than conventional cascoded transistors.

In general, the diode string allows increased flexibility to support mixed voltage applications without sacrificing ESD performance. The operating voltage can be tailored for a given bottom transistor by simply changing the number of diodes in the diode string (e.g., include in the design the number of diodes necessary to handle the maximum expected operating voltage). The ESD performance of the,diode string has been found to be fairly insensitive to the number of diodes. Furthermore, the performance of the diode string and the bottom NMOS transistor in the cascode configuration has generally robust ESD performance that is comparable to that of a single NMOS device (e.g., a transistor).

In accordance with one or more embodiments of the present invention, a diode string and a transistor are arranged in a cascode configuration to provide a circuit capable of operating at mixed voltage levels. The circuit may operate without violating dielectric or hot carrier reliability limits or leakage current limits. Furthermore, the circuit may provide a lower snapback voltage, a lower holding voltage, a smaller layout, and/or improved ESD performance relative to some conventional circuits. The diode string may include any number of diodes, which may be arranged in various configurations, to support the desired operating voltages.

Embodiments described above illustrate but do not limit the invention. It should also be understood that numerous modifications and variations are possible in accordance with the principles of the present invention. Accordingly, the scope of the invention is defined only by the following claims.

1. A circuit comprising:
a diode string coupled to a supply voltage line; and
a transistor coupled to the diode string and to a reference voltage line, wherein the diode string and the transistor are implemented in a cascode configuration and provide electrostatic discharge protection.

2. The circuit of claim 1, wherein the diode string comprises:
at least a first diode coupled between the supply voltage line and the reference voltage line and adapted to provide electrostatic discharge protection having a first polarity; and
at least a second diode coupled to the supply voltage line and adapted to provide electrostatic discharge protection having a second polarity.

3. The circuit of claim 2, wherein the second diode has at least a first terminal coupled to a drain terminal of the transistor.

4. The circuit of claim 1, wherein the transistor and the diode string have different diffusion regions.

5. The circuit of claim 1, further comprising a resistor coupled between a gate terminal of the transistor and the reference voltage line, wherein the circuit provides electrostatic discharge protection for a power rail of an integrated circuit incorporating the circuit.

6. The circuit of claim 1, further comprising a pull-up circuit coupled between the supply voltage line and the diode string, wherein the pull-up circuit and the diode string are coupled to an input pad and/or an output pad, the transistor is adapted to receive a control signal at its gate terminal, and the circuit provides electrostatic discharge protection for an interface of an integrated circuit incorporating the circuit.

7. The circuit of claim 6, wherein the circuit is adapted to operate as a driver.

8. The circuit of claim 1, wherein the circuit is adapted to operate in a mixed voltage environment.

9. The circuit of claim 1, wherein one or more diodes within the diode string may be implemented as bipolar transistors.

10. A programmable logic device comprising:
at least a first diode coupled between a supply voltage line and a reference voltage line and adapted to protect from electrostatic discharge of a first polarity;
at least a second diode coupled between the supply voltage line and the reference voltage line and adapted to protect from electrostatic discharge of a second polarity; and
a transistor coupled between the at least first diode and the reference voltage line.

11. The programmable logic device of claim 10, wherein the transistor and the at least first diode are implemented in a cascode configuration and adapted to operate in a mixed voltage environment.

12. The programmable logic device of claim 11, wherein the transistor and the at least first diode have different diffusion regions.

13. The programmable logic device of claim 10, further comprising a resistor coupled between a gate terminal of the transistor and the reference voltage line, wherein the at least first diode, the at least second diode, the transistor, and the resistor provide electrostatic discharge protection for a power rail of the programmable logic device.

14. The programmable logic device of claim 10, wherein the at least second diode has a first terminal coupled to a drain terminal of the transistor.

15. The programmable logic device of claim 10, further comprising a pull-up circuit coupled between the supply voltage line and the at least first diode, wherein the pull-up circuit and the at least first diode are coupled to a pad, the transistor is adapted to receive a control signal at its gate terminal, and the at least first diode, the at least second diode, and the transistor provide electrostatic discharge protection for an interface of the programmable logic device.

16. The programmable logic device of claim 10, wherein the at least first diode and/or the at least second diode comprise a bipolar transistor.

17. A method of providing electrostatic discharge protection, the method comprising:
providing at least a first diode coupled to a supply voltage rail to protect from electrostatic discharge of a first polarity;
providing a transistor coupled between the at least first diode and a reference voltage rail; and
providing at least a second diode coupled to the supply voltage rail and to the reference voltage rail or between the at least first diode and the transistor to protect from electrostatic discharge of a second polarity, wherein the at least first diode and the transistor are implemented in a cascode configuration.

18. The method of claim 17, wherein the at least first diode and the transistor are implemented having different diffusions.

19. The method of claim 17, further comprising operating the at least first diode, the at least second diode, and the transistor as a clamp circuit.

20. The method of claim 17, further comprising operating the at least first diode, the at least second diode, and the transistor as a driver to transfer data via a pad.

21. The method of claim 17, further comprising providing a pull-up circuit between the supply voltage rail and the at least first diode.

22. The method of claim 17, wherein the at least first diode and/or the at least second diode comprise a bipolar transistor.
